(19) United States
(12) Patent Application Publication
(10) Pub. No.: US 2026/0041285 A1
(43) Pub. Date: Feb. 12, 2026

(54) Cutting (non-stick) and Serving Tongs with spring and lock system

(71) Applicant: Tamiraa Hauptman, Kihei, HI (US)

(72) Inventor: Tamiraa Hauptman, Kihei, HI (US)

(21) Appl. No.: 18/800,045

(22) Filed: Aug. 10, 2024

(51) Int. Cl. A47J 43/28; B25G 1/10; B26B 17/00

(52) U.S. Cl. CPC A47J 43/283; B25G 1/102; B26B 17/00

(57) ABSTRACT

The present invention comprises a novel cutting device generally consisting of a tong-like shape, which is capable of slicing and then lifting a shaped piece from a larger whole. Different shapes may be used to perform substantially the same action, resulting in different shapes taken from the whole. The tongs have an angled (45 degrees) handle to provide comfort for the user's wrist and forearm.

### PURPOSE OF INVENTION

Cutting pieces into shapes with sharp edged blades and grasping and lifting shaped pieces of items with tong handles then transfer from one container or surface onto another away from the whole piece with the use of only one hand with one utensil.

### DESCRIPTION OF PROBLEM(S) THAT THIS INVENTION SOLVES

Items in a container or food in a dish can be difficult to cut and lift out of the container after cutting without use of a second tool or utensils. This invention allows the user an ability to cut a piece into a shape that is located in a container and then lift the cut piece out of the container onto another by using only one hand and one utensil.

### DESCRIPTION ON HOW THE INVENTION IS AN IMPROVEMENT OVER EXISTING TECHNOLOGY

Existing technology requires user's two hands and two or more cutting and lifting utensils that are typically a long pointed knife and a spatula(s) or a serving utensil(s) to lift out a piece that has been cut. The Invention allows the operation to be efficiently completed with only one hand and one utensil.

### DESCRIPTION OF THE BENEFITS OF THIS INVENTION TO ITS USERS

The Invention will allow a user to cut out a piece of food or other material and lift it out of the container without using another utensil. For example: as normally at weddings or birthday parties when cakes are cut, there is a big pointy knife used for cutting the cake and then a cake server(s) or a spatula used to transfer cut pieces onto serving dishes. It will result a piece cut into a smaller piece that is being retained in the device's blade head that forms the food or material into a shape, and then it requires less need for additional utensils to transfer the piece or cut item, simplifying the use of multi utensils for cutting and serving or transferring pieces with ergonomic handles. The handles of the invention are designed for ease of use from an ergonomic standpoint to easily cut and pinch the tong handles to transfer items onto serving plates or other containers while alleviating the stress of repetitive wrist movements normally caused due to awkward angles. Also, the Invention offers different shapes and sizes that allows creativity for the user and it is not limited to cutting and serving cakes but also for cookies, pies, pizzas, deep dishes, etc. This tool can also be used for pottery, glass blowing inventions and other designing purposes. Also, this invention can be implemented in robotic manufacturing technology for food and/or manufacturing of other items to cut down into precise & clean-cut pieces and transfer each item into individual containers.

The Invention has a non-stick coating on the cutter, just above the blade line.

### BRIEF DESCRIPTION OF THE INVENTION

Tongs with ergonomic handles and shaped ends that each have sharp blade edges for cutting.

### Illustrations Brief Description

The illustrations show 3D renderings/images of the Invention from different angles. Also shown are different shapes that can be used to cut different forms. Also shown are the spring and lock system, where spring allows the tong to stay spread open which allows the user to use pressure to the desired closure level and the lock system allows the device to be closed up and locked for storing. Also, the illustrations show non-stick coating on cutting part of the tong.
https://drive.google.com/file/d/1eibTBxbujyXtQ4_avLt70IFJE_SxijrH/view?usp=sharing
https://drive.google.com/file/d/1o1YJaaKtzQGCSAlcDyLXhBz-IcDUo-Fz/view?usp=sharing
https://drive.google.com/file/d/1NTMlXq95cUI6KwDFJ_tEbfko2vgFcDrQ/view?usp=sharing
https://drive.google.com/file/d/1K_fhntJwBSFZb8bEW4zwHSUsXSKrl4Yx/view?usp=sharing

### Description of the Cutting Tong

### 1. Design and Structure

The cutting tong consists of two primary components: a tong handle and a cutting blade.
The handle is ergonomically designed with two loops for fingers, providing a comfortable and secure grip for the user.
The cutting blade is integrated into the tong mechanism, positioned at the end of the handle. The blade can be square-shaped or triangle-shaped, circle, etc., allowing for precise and controlled cutting each time.

### 2. Material and Construction

The tool is constructed from a durable metallic material, like stainless steel or a similar alloy, ensuring longevity and resistance to wear and corrosion. Also, food grade plastic can be used for simpler versions.
The blade is designed to maintain its sharpness over time, providing consistent cutting performance. However, for the plastic version, the blade will be duller (like plasticware knife) with a lesser lifespan like all other plasticware items.

### 3. Functional Features

The tong mechanism allows for easy manipulation and control of the cutting blade, enabling the user to make precise cuts with minimal effort.
The shaped blade is ideal for cutting through various materials, offering versatility in its applications
The spring system allows the tong to stay spread open which allows the user to use pressure to the desired closure level
The lock system allows the device to be closed up and locked for storing.
Also non-stick coating on the blade part allows clean cutting and transferring items for repeated steps.
The compact and streamlined design of the tool makes it suitable for use in specialized or industrial settings where precision and efficiency are paramount.

### 4. Potential Applications:

In addition to food service applications, the cutting tong can be used in a variety of industries, including manufacturing, crafting, and food processing, where precise cutting and lifting are essential.
Its ergonomic design and durable construction make it suitable for regular use in demanding environments.
The spring and lock system, where spring allows the tong to stay spread open which allows the user to use pressure to the desired closure level and the lock system allows the device to be closed up and locked for storing.

### Innovative Aspects

The integration of a cutting blade into a tong mechanism represents a novel approach to cutting tools, combining the functionality of tongs and blades into a single, efficient device.
The ergonomic handle design enhances user comfort and control, reducing hand fatigue during prolonged use.
The durable materials and construction ensure that the tool can withstand regular use and maintain its cutting performance over time. However, food grade plastic can be used similarly to other plasticware uses.

### INVENTION DETAILED DESCRIPTION

### Description of the Parts of the Invention:

### Description of the Parts of the Invention:

Our product includes.
1. Handle with Finger Holes
2. Pivot Pin
3. Cutting Blade Heads of different shapes.
   1. Handle with Finger Holes

Each cutter has handles with proper finger hole for better gripping while using it and bent in angle for comfort on the wrist

### 2. Pivot Pin

Pivot Pin is the point from where both the parts pivots on angles to open and close the cutter head

### 3. Cutting Blades of Different Shapes

Each Cutter has a different shape of cutting edge so that it can be used for cutting whole piece food or other items into individual pieces as per need. Also, the cutter head encloses in the cut piece for grasping and containment while lifting it up Relationship between the Parts of the Invention:

The invention is a Cutting and grasping device consisting of 2 solid pieces cross joined in the mid-section of the device handle. The shaped ends have sharp knife edges/blades for cutting and the shape encloses the cut piece within. The enclosed shape then will allow the item to be grasped and lifted away from the whole piece using tong handles which will slightly pinch the shape head and transfer items to a new location.

1. Primary Claim: Multifunctional Cutting Tongs
Combines cutting, grasping, and lifting functions in a single utensil
Features ergonomic handles with finger holes for improved grip
Incorporates cutting blade heads of various shapes for precise cutting and lifting

2. The cutting tongs of claim 1, wherein the cutting blade heads are shaped to enclose and secure cut pieces for easy lifting and transfer.
Enhanced Cutting and Transfer Capability
Consolidates cutting, serving, and transferring functions
Sharp edges on tong heads for slicing whole items
Preserves shape of cut piece during transfer

3. The cutting tongs of claim 1, further comprising:
Detailed Design and Versatility Claim:
Pivot pin connecting arms for controlled movement
Handles angled at 45 degrees to reduce wrist strain
Cutting blade heads with sharp edges in various shapes
Versatile applications beyond food preparation (e.g., pottery, glass blowing)
Adaptable for automated systems and robotic manufacturing
